(19) United States
(12) Patent Application Publication
(10) Pub. No.: US 2017/0105566 A1
(43) Pub. Date: Apr. 20, 2017

(54) AUTOMATIC COOKING DEVICE

(71) Applicant: ZhuHai Cooker Intelligent Science& Technology Co., LTD, Zhuhai (CN)

(72) Inventor: Keliang JIANG, Zhuhai (CN)

(73) Assignee: ZhuHai Cooker Intelligent Science&Technology Co., LTD, Zhuhai (CN)

(21) Appl. No.: 15/128,988

(22) PCT Filed: Mar. 23, 2015
(86) PCT No.: PCT/CN2015/074853

§ 371 Date: Sep. 25, 2016

(30) Foreign Application Priority Data
Mar. 26, 2014 (CN) 201420142231.1

(51) Int. Cl. A47J 27/00; A47J 36/00; A47J 43/04

(52) U.S. Cl. CPC A47J 27/002; A47J 43/04; A47J 36/00

(57) ABSTRACT

The invention discloses an automatic cooking device, comprising a main machine, a pot body, a spatula, a spatula driving apparatus and a blocking frame, wherein: a lower opening of a feed passage of the blocking frame is jointed with a top opening of the pot body; the spatula is configured to swing in a reciprocating manner between a first limit position and a second limit position by means of the drive of the spatula driving apparatus; the main machine comprises a control box and a frame; a pot mouth encircling edge is provided along an edge of the top opening of the pot body; at least one part of the pot mouth encircling edge and a lower rim of the blocking frame form a slidable contact fit; and a protruding blocking part is formed on the pot mouth encircling edge at the periphery of the blocking frame.

### TECHNICAL FIELD

The present invention relates to a cooking device, and more particularly to an easy-to-clean automatic cooking device. This application claims the priority of the Chinese patent application No. 201420142231.1, entitled as “Automatic Cooking Device”, filed to the Patent Office of the State Intellectual Property Office of China on Mar. 26, 2014, which is incorporated by reference in its entirety.

### BACKGROUND ART

With an accelerated pace of life and the use of the kitchen revolution, automated cooking devices have overwhelmingly become the mainstream. Microwave ovens, as common automated cooking devices, have been increasingly used. However, as imported goods, microwave ovens are much more suitable for foreigners' living habits. After being introduced into China, microwave ovens are substantially produced based on foreign technologies. Generally, Chinese consumers just use them to heat food. In recent years, although new models appear, restraints on the simple heating function of microwave ovens have not been broken yet.

For the above problems, some automatic cooking devices, also named as “automatic cooking machines”, able to better meet. Chinese people's living habits have appeared. An automatic cooking machine is a machine capable of professionally simulating human cooking without human supervision, and is also an intelligent automatic cooking device capable of automatically heating oil, stir-frying and controlling heat without any experience so long as prepared primary ingredients, secondary ingredients and seasonings are fed in one time and then programs are set. With the automatic cooking machine, automation and interest are realized in a cooking process, while realizing truly fume-free, time-saving, labor-saving, non-sticking and non-burning cooking. Thus, not only are traditional crafts and color of Chinese dishes maintained, but also the cooked dishes are fresh, delicious and nutritious.

However, through research, the inventor found that there are some problems common in those automatic cooking devices. For example, their structures are complex and even unreasonable, and dead corners for cleaning are likely to appear; juices seep out of a pot abnormally to soil device parts and external environment during normal use; and members requiring cleaning are hard to identify, assemble and dissemble, resulting in inconvenience or even difficulty in cleaning.

### SUMMARY

One object of the present invention is to provide an automatic cooking device capable of effectively preventing juice seeping and dead corners for cleaning and easy to disassemble, assemble and clean to overcome the deficiencies in the prior art.

Another object of the present invention is to provide an automatic cooking device capable of automatically collecting waste water to keep the surface of the device clean and reduce the cleaning workload.

To achieve the above first object, the present invention adopts the following technical solution: there is designed an automatic cooking device comprising a main machine, a pot body, a spatula, a spatula driving apparatus and a blocking frame located above the pot body, wherein: the blocking frame is provided with a feed passage with an upper opening and a lower opening; the lower opening of the feed passage is jointed with a top opening of the pot body; the spatula is located in a cavity encircled by the blocking frame and the pot body, is configured to swing in a reciprocating manner between a first limit position and a second limit position by means of the drive of the spatula driving apparatus, and is provided with a working face which is opposite to a cooking face of the pot body and complementary with the cooking face in shape; the main machine comprises a control box and a frame; a pot mouth encircling edge is provided along an edge of the top opening of the pot body, and at least one part of the pot mouth encircling edge and a lower rim of the blocking frame form a slidable contact fit; and a protruding blocking part is formed on the pot mouth encircling edge at the periphery of the blocking frame, and a top face of the blocking part is higher than the joint seam between the pot mouth encircling edge and the lower rim of the blocking frame.

It can be seen from the above solution that in the automatic cooking device provided by the present invention, as the lower rim of the blocking frame and the pot mouth encircling edge form a slidable contact fit, juices generated in a cooking process is unlikely to seep out of the joint seam between the blocking frame and the pot body. Meanwhile, as the protruding blocking part is formed on the pot mouth encircling edge at the periphery of the blocking frame, and the top face of the blocking part is higher than the joint seam between the pot mouth encircling edge and the lower rim of the blocking frame, even some juices seep out of the joint seam, the blocking part still can effectively block the juices to prevent the juices from flowing outside the blocking frame and the pot body to soil the device, thus reducing the cleaning workload. Moreover, the juices are prevented from sticking and hanging on an outer surface of the pot body to avoid a condition that the juices fall down on the kitchen countertop and the floor when the pot body is moved out of the main machine.

Preferably, after the blocking frame is detachably placed in the frame, the lower rim of the blocking frame and the pot mouth encircling edge form a slidable contact fit.

Further, an upper surface of the frame is provided with a waste water trough, and a water drainage hole is arranged in the waste water trough and is in communication with a waste water box. By adopting the above design, distilled water and other dirt gathered in the waste water trough may flow to the waste water box via the water drainage hole, so that waste water is collected automatically, the surface of the frame is kept clean, and the cleaning workload is reduced.

Further, a pot cover is arranged on the frame, and the pot cover is provided with a closed state when placed horizontally at the top of the frame and an open state when placed vertically at the top of the frame. During normal cooking, there is distilled water on the inner surface of the pot cover; if the pot cover is placed on the table board, the distilled water will flow onto the table board to soil the table board; if the pot cover is vertically placed at the top of the frame, there is no need to place the pot cover on the kitchen countertop randomly, so that the kitchen countertop is prevented from being soiled.

Further, a blocking frame flange is arranged on an upper rim of the blocking frame; and when the pot cover, vertically placed at the top of the frame, is in the open state, an inner rim of the pot cover is in contact with a lower rim of the blocking frame flange, and an outer surface of the pot cover is in contact with an outer rim of the waste water trough. Through the above design, not only can the pot cover be vertically placed at the top of the frame stably, but also in a process of switching the horizontally placed pot cover in the closed state to the vertically placed pot cover in the open state, the distilled water on the inner surface of the pot cover flows to the waste water trough on the upper surface of the frame, thus preventing the distilled water from flowing randomly.

Further, hangers are arranged at the lower part of the frame and configured to support the pot body, and a lower surface of the pot mouth encircling edge and a supporting surface of the hangers form a slidable fit. With this structure, a user can conveniently draw the pot body out of or push the pot body into the main machine horizontally. Meanwhile, the possibility that the hangers are in contact with dirty water is reduced, and the hangers may avoid influence on cleaning of the spatula and the blocking frame to the greatest extent.

Preferably, the upper opening of the feed passage is larger than or equal to the lower opening of the feed passage, so that sectional areas of the feed passage keep constant or become smaller and smaller from the upper opening to the lower opening of the feed passage.

Preferably, an inner surface of the blocking frame comprises a vertical plane, an outwardly inclined plane, an evaginable camber surface or an outwardly-folded combined plane.

It can be seen from the above solution that if a user overlooks the upper opening of the blocking frame, he/she can see the entire inner surface of the blocking frame, and a cleaning tool can easily reach the entire inner surface, so that the cleaning is convenient and dirty dead corners are unlikely to be left.

Further, the automatic cooking device provided by the present invention comprises the waste water box which is detachably connected to the main machine and arranged below the pot body. The waste water box is mainly used for collecting waste water when the device is cleaned on any kitchen countertop.

Further, a lower part of the main machine is coimected with a support for allowing the main machine to be stably placed during use or cleaning and/or for supporting the waste water box. Through the support, not only are the overall stationarity and strength of the device ensured, but also cleaning of the device on a sink is convenient; and if the waste water box is arranged, the support can also be used for supporting the waste water box.

Further, the blocking part is arranged along an outer horizontal edge and two vertical edges of the pot mouth encircling edge. With such design, the pot body may be pushed and drawn smoothly, and is prevented from being blocked by the blocking frame in a pushing/drawing process.

Further, when swinging to the first limit position and/or the second limit position, the spatula is located above the top opening of the pot body. Here, the pot body may be drawn out of the machine body in a slidable manner for pouring out of dishes and cleaning when separated from the main machine. Meanwhile, there is no block on the spatula, so it is convenient to clean.

To achieve the above second object, the present invention adopts the following technical solution: there is an automatic cooking device comprising a main machine, a pot body, a spatula, a spatula driving apparatus and a blocking frame located above the pot body, wherein: the blocking frame is provided with a feed passage with an upper opening and a lower opening; the lower opening of the feed passage is jointed with a top opening of the pot body; the spatula is located in a cavity encircled by the blocking frame and the pot body, is configured to swing in a reciprocating manner between a first limit position and a second limit position by means of the chive of the spatula driving apparatus, and is provided with a working face which is opposite to a cooking face of the pot body and complementary with the cooking face in shape; the main machine comprises a control box and a frame; an upper surface of the frame is provided with a waste water trough; a water drainage hole is arranged in the waste water trough; and the water drainage hole is in communication with a waste water box.

It can be seen from the above solution that as the upper surface of the frame is provided with the waste water trough, the waste water can be automatically collected; and distilled water and other dirt gathered in the waste water trough may flow to the waste water box via the water drainage hole, so that the surface of the frame is kept clean, and the cleaning workload is reduced.

Further, a pot cover is arranged on the frame, and the pot cover is provided with a closed state when placed horizontally at the top of the frame and an open state when placed vertically at the top of the frame. During normal cooking, there is distilled water on the inner surface of the pot cover; if the pot cover is placed on the kitchen countertop, the distilled water will flow onto the kitchen countertop to soil the kitchen countertop; if the pot cover is vertically placed at the top of the frame, there is no need to place the pot cover on the kitchen countertop randomly, so that the kitchen countertop is prevented from being soiled.

Further, a blocking frame flange is arranged on an upper rim of the blocking frame; and when the pot cover, vertically placed at the top of the frame, is in the open state, an inner rim of the pot cover is in contact with a lower rim of the blocking frame flange, and an outer surface of the pot cover is in contact with an outer rim the waste water trough. Through the above design, not only can the pot cover be vertically placed at the top of the frame stably, but also in a process of switching the horizontally placed pot cover in the closed state to the vertically placed pot cover in the open state, the distilled water on the inner surface of the pot cover flows to the waste water trough on the upper surface of the frame, thus preventing the distilled water from flowing randomly.

Further, a pot mouth encircling edge is provided along an edge of the top opening of the pot body, and at least one part of the pot mouth encircling edge and a lower rim of the blocking frame form a slidable contact fit. A protruding blocking part is formed on the pot mouth encircling edge at the periphery of the blocking frame, and a top face of the blocking part is higher than the joint seam between the pot mouth encircling edge and the lower rim of the blocking frame.

It can be seen from the above solution that as the lower rim of the blocking frame and the pot mouth encircling edge form a slidable contact fit, juices generated in a cooking process is unlikely to seep out of the joint seam between the blocking frame and the pot body. Meanwhile, as the protruding blocking part is formed on the pot mouth encircling edge at the periphery of the blocking frame, and the top face of the blocking part is higher than the joint seam between the pot mouth encircling edge and the lower rim of the blocking frame, even some juices seep out of the joint seam, the blocking part still can effectively block the few of juices to prevent the juices from flowing outside the blocking frame and the pot body to soil the device, thus reducing the cleaning workload. Moreover, the juices are prevented from sticking and hanging on an outer surface of the pot body to avoid a condition that the juices fall down on a kitchen countertop and a floor when the pot body is moved out of the main machine.

Further, hangers are arranged at the lower part of the frame and configured to support the pot body, and a lower surface of the pot mouth encircling edge and a supporting surface of the hangers form a slidable fit. With this structure, a user can conveniently draw the pot body out of or push the pot body into the main machine horizontally. Meanwhile, the possibility that the hangers are in contact with dirty water is reduced, and the hangers may avoid influence on cleaning of the spatula and the blocking frame to the greatest extent.

Preferably, the upper opening of the feed passage is larger than or equal to the lower opening of the feed passage, so that sectional areas of the feed passage keep constant or become smaller and smaller from the upper opening to the lower opening of the feed passage.

Preferably, an inner surface of the blocking frame comprises a vertical plane, an outwardly inclined plane, an evaginable camber surface or an outwardly-folded combined plane.

It can he seen from the above solution that if a user overlooks the upper opening of the blocking frame, he/she can see the entire inner surface of the blocking frame, and a cleaning tool can easily reach the entire inner surface, so that the cleaning is convenient and dirty dead corners are unlikely to be left.

Further, the automatic cooking device provided by the present invention comprises the waste water box which is detachably connected to the main machine and arranged below the pot body. The waste water box is mainly used for collecting waste water when the device is cleaned on any kitchen countertop.

Further, a lower part of the main machine is coimected with a support for allowing the main machine to be stably placed during use or cleaning and/or supporting the waste water box. Through the support, not only are the overall stationarity and strength of the device ensured, but also cleaning of the device on a sink is convenient. If the waste water box is arranged, the support can also be used for supporting the waste water box.

Further, the blocking part is arranged along an outer horizontal edge and two vertical edges of the pot mouth encircling edge. With such design, the pot body may be pushed and drawn smoothly, and is prevented from being blocked by the blocking frame in a pushing/drawing process.

Further, when swinging to the first limit position and/or the second limit position, the spatula is located above the top opening of the pot body. Here, the pot body may be drawn out of the machine body in a slidable manner for pouring out dishes and cleaning when separated from the main machine. Meanwhile, there is no block on the spatula, so it is convenient, to clean.

In conclusion, compared with the prior art, the automatic cooking device provided by the present invention is simple in structure, convenient to use and easy to clean.

### BRIEF DESCRIPTION OF THE DRAWINGS

FIG. 1 shows a perspective view of an automatic cooking device according to an embodiment of the present invention.

FIG. 2 shows a perspective view of the automatic cooking device shown in FIG. 1 without a pot cover.

FIG. 3 shows an exploded view of the automatic cooking device shown in FIG. 2.

FIG. 4 shows a side view of the automatic cooking device shown in FIG. 2.

FIG. 5 shows an A-A sectional view of a spatula, swinging to a middle position, of the automatic cooking device shown in FIG. 2.

FIG. 6 shows an A-A sectional view of the spatula, swinging to a first limit position, of the automatic cooking device shown in FIG. 2.

FIG. 7 shows an A-A sectional view of the spatula, swinging to a second limit position, of the automatic cooking device shown in FIG. 2.

FIG. 8 shows a partial enlarged view of a position C shown in FIG. 5.

FIG. 9 shows a B-B sectional view of the automatic cooking device shown in FIG. 5.

FIG. 10 shows a perspective view of the automatic cooking device when the pot cover is vertically placed at the top of a frame according to an embodiment of the present invention.

FIG. 11 shows a sectional view of the automatic cooking device shown in FIG. 10.

FIG. 12 shows a schematic drawing of a first cleaning state of the automatic cooking device provided by the present invention.

FIG. 13 shows a schematic drawing of a second cleaning state of the automatic cooking device provided by the present invention.

FIG. 14 shows a schematic drawing of a third cleaning state of the automatic cooking device provided by the present invention.

### DETAILED DESCRIPTION

Various embodiments of the present invention will be described in detail herein, and the embodiments are explained with reference to the accompanying drawings. Although the present invention is explained in combination with the exemplary embodiments, it should be understood that the present invention is not limited to these exemplary embodiments. Instead, the present invention comprises not only these embodiments, but also various modifications and improvements thereof.

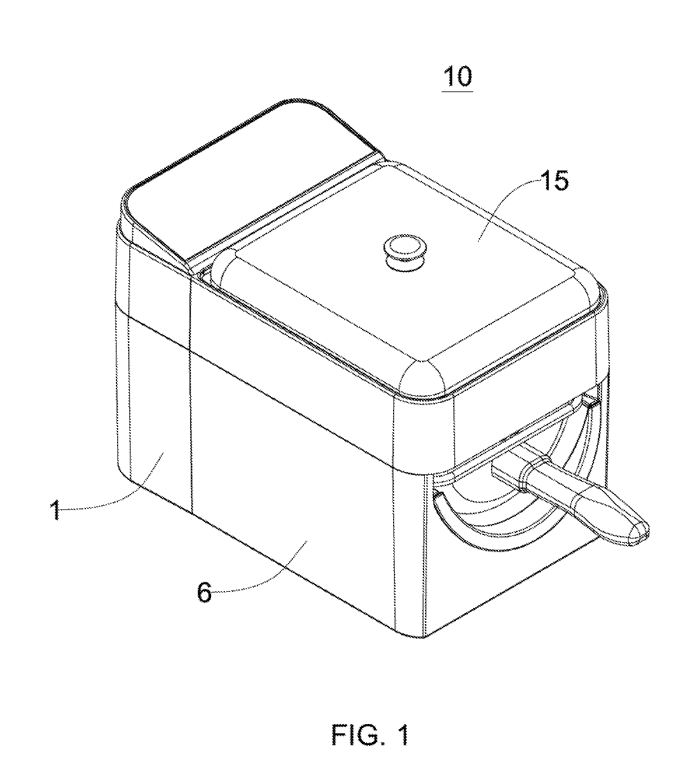

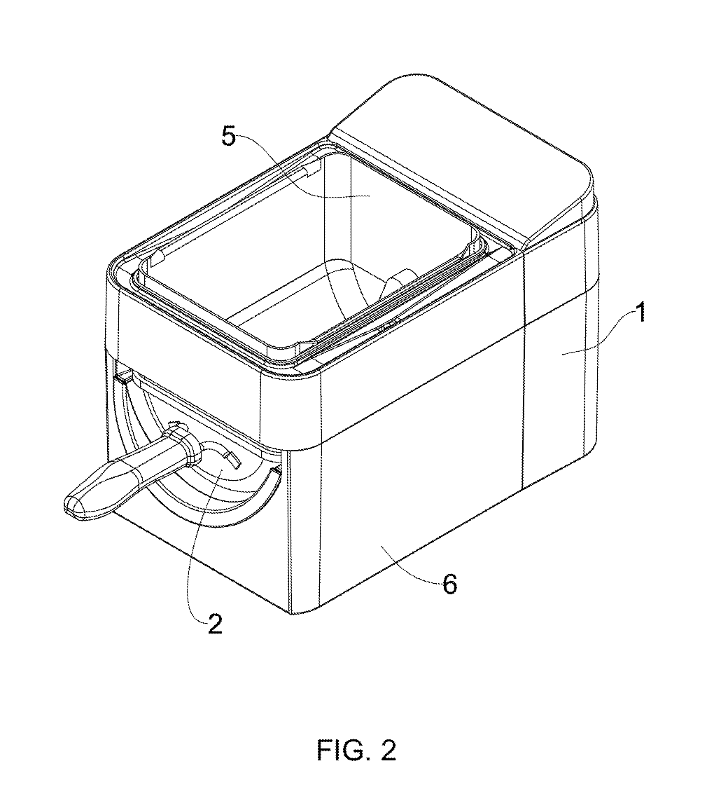

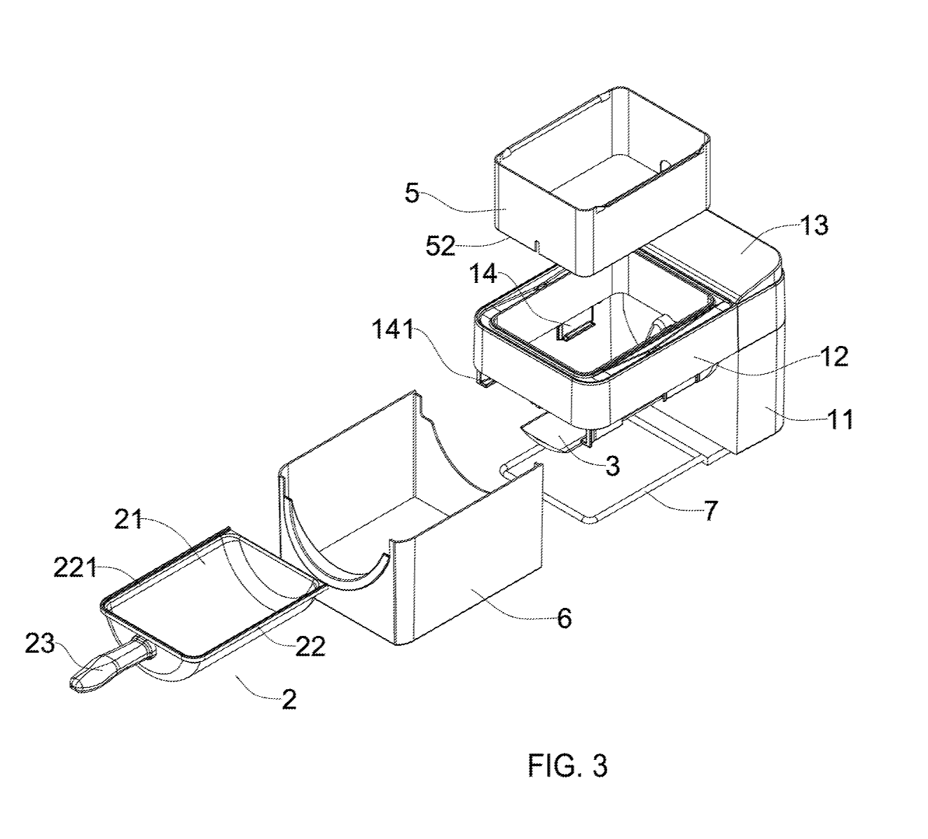

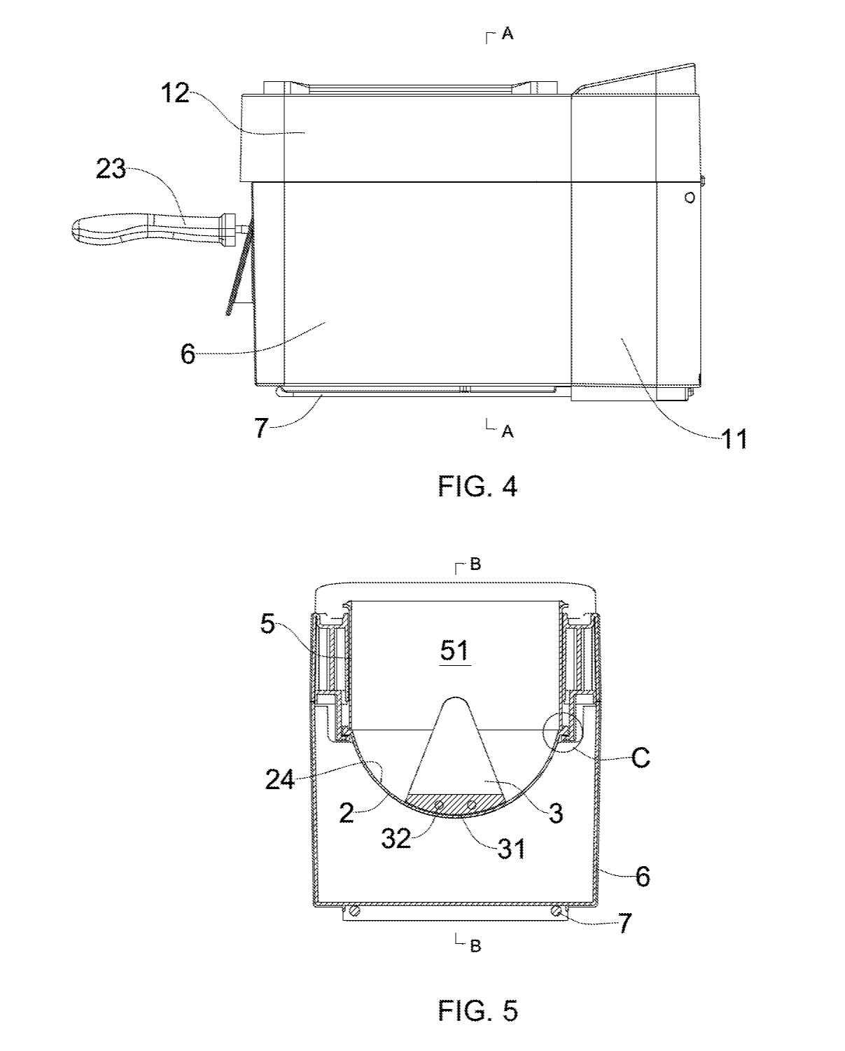

As shown in FIGS. 1-3, automatic cooking device 10 according to an embodiment of the present invention comprises a main machine 1, pot body 2, spatula 3, spatula driving apparatus 4, blocking frame 5, waste water box 6, support 7, pot cover 15 and a microcomputer control unit, wherein waste water box 6 is detachably connected to main machine 1 to form a substantially cuboid box body. When connected to main machine 1, waste water box 6 is located below pot body 2 and supported by support 7 below the waste water box. Support 7 is horizontally connected and fixed to main machine 1. In the present embodiment, support 7 is a U-shaped wire frame. Through support 7, not only are the overall stationarity and strength of the device ensured, but also cleaning of the device on a sink is convenient. Waste water box 6 is mainly used for collecting waste water when the device is directly placed on a kitchen countertop to be cleaned.

Main machine 1 is composed of control box 11 and frame 12 horizontally extending outwards from the upper part of control box 11; pot cover 15 is arranged at the top of frame 12 the top face of control box 11 is provided with control panel 13; and control panel 13 may be an LCD touch panel integrating display and control, and may adopt a button, a knob, an indicating lamp or the like to set functions and display working states.

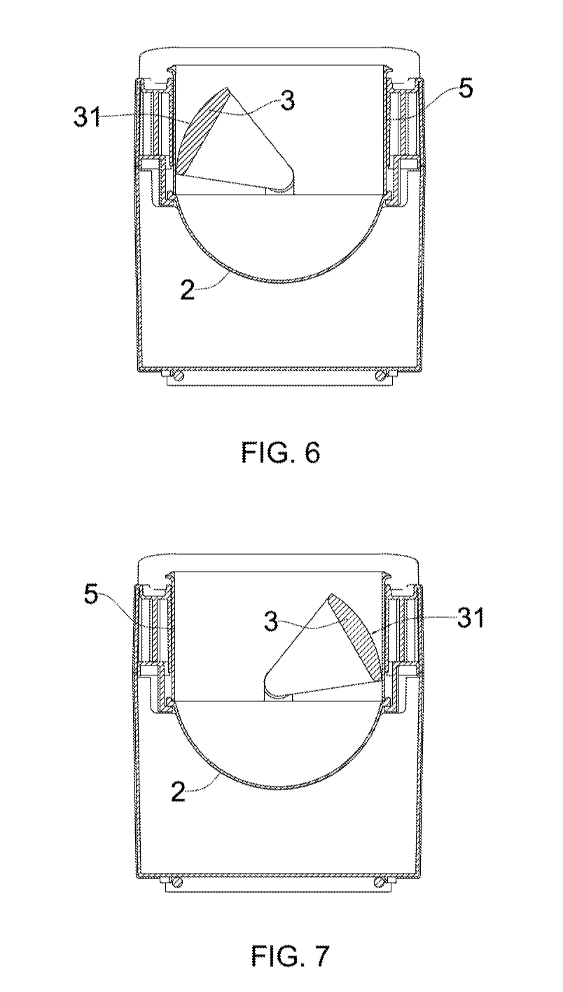

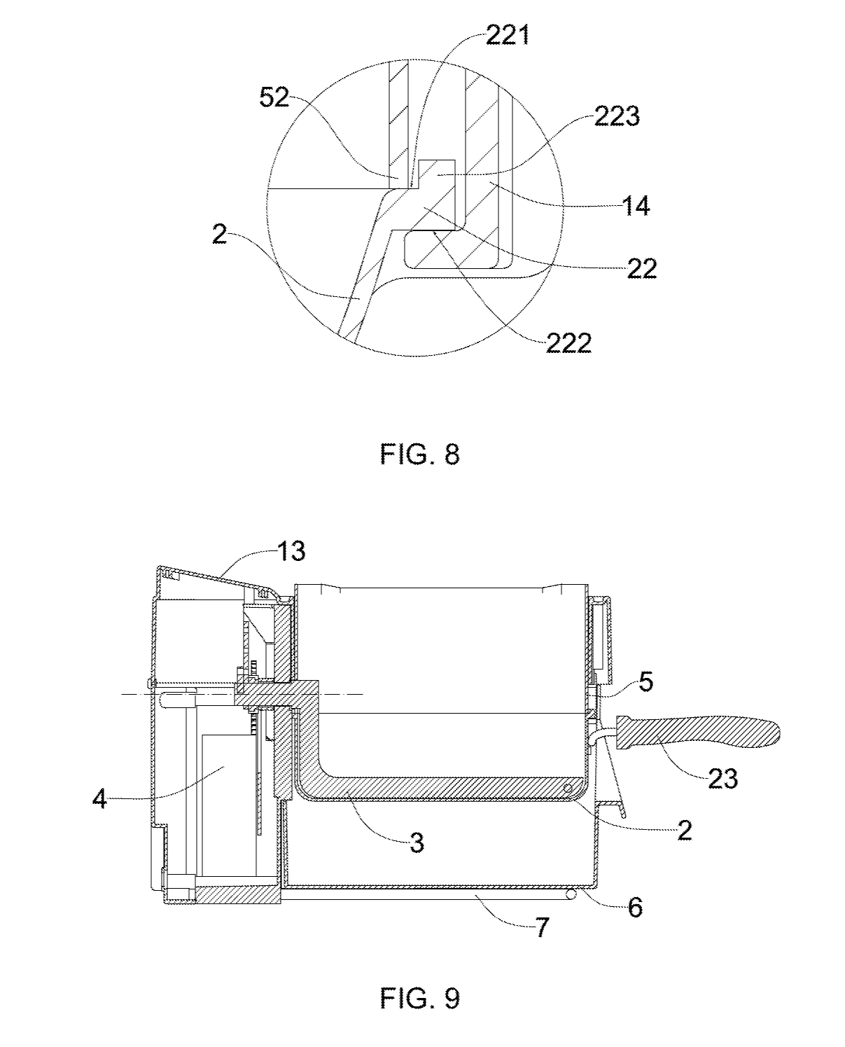

Spatula 3 may be pivotally supported on frame 12, and whole spatula 3 is located in a cavity encircled by blocking frame 5 and pot body 2. Spatula driving apparatus 4 and spatula 3 form a drivable connection. Spatula driving apparatus 4 and the microcomputer control unit (not shown in the Figures) are arranged in control box 11, and spatula driving apparatus 4 can receive an instruction from the microcomputer control unit to drive spatula 3 to swing in a reciprocating manner between a first limit position shown in FIG. 6 and a second limit position shown in FIG. 7. Spatula driving apparatus 4 may be a driving motor, and is connected with spatula 3 via a crank-rocker mechanism and a gear transmission mechanism. Of course, spatula driving apparatus 4 may employ other driving manners so long as spatula 3 is driven to swing in a reciprocating manner between the two limit positions. Electric heating element 32 controlled by the microcomputer control unit is arranged inside spatula 3, and is used for heating spatula 3 to suitable temperatures according to specific cooking needs.

Two sides of frame 12 extend downwards and are provided with two hangers 14 for supporting pot body 2 respectively. Pot body 2 is supported on supporting surface 141 of hangers 14. Blocking frame 5 is detachably placed in frame 12 of main machine 1 to enable the blocking frame to be conveniently taken out for cleaning. When blocking frame 5 is placed in frame 12, a lower rim of blocking frame 5 and pot mouth encircling edge 22 which will be referred to below form a slidable contact fit.

Pot body 2 is a substantially semi-cylindrical metal housing; handle 23 is arranged at an outer end of pot body 2; the top of pot body 2 is provided with opening 21; pot mouth encircling edge 22 is arranged along the edge of top opening 21; and the inner surface of pot body 2 is cooking face 24. A user can draw out of or push in pot body 2 in the horizontal direction via handle 23. In a process that pot body 2 is moved in the horizontal direction, lower surface 222 of pot mouth encircling edge 22 and supporting surface 141 of hangers 14 form a slidable fit.

In the present embodiment, blocking frame 5 is a rectangular frame. Feed passage 51 with an upper opening and a lower opening is arranged inside the blocking frame, and the upper opening and the lower opening of the feed passage are basically the same. The lower opening of feed passage 51 is jointed with top opening 21 of pot body 2. Spatula 3 is provided with working face 31 which is opposite to cooking face 24 of pot body 2 and complementary with the cooking face in shape. Lower rim 52 of blocking frame 5 and inside top face 221 of pot mouth encircling edge 22 form a slidable contact fit. Protruding blocking part 223 is formed on pot mouth encircling edge 22 at the periphery of blocking frame 5. A top face of blocking part 223 is higher than the joint seam between pot mouth encircling edge 22 and lower rim 52 of the blocking frame; and that is, the top face of the blocking part is higher than a lower end face of blocking frame 5. Blocking part 223 is arranged along an outer horizontal edge and two vertical edges of pot mouth encircling edge 22. That is, blocking part 223 is not arranged on an inside horizontal edge of pot mouth encircling edge 22. With such design, pot body 2 may be pushed and drawn smoothly. and is prevented from being, blocked by blocking frame 5 in a pushing/drawing process.

As lower rim 52 of blocking frame 5 and inside top face 221 of pot mouth encircling edge 22 form a slidable contact fit, juices generated in a cooking process is unlikely to seep out of the joint seam between blocking frame 5 and pot body 2. As protruding blocking part 223 is formed on pot mouth encircling edge 22 at the periphery of blocking frame 5, and the top face of blocking part 223 is higher than the joint seam between pot mouth encircling edge 22 and lower rim 52 of the blocking frame, even some juices seep out of the joint seam, blocking part 223 still can effectively block the few juices to prevent the juices from flowing outside blocking frame 5 and pot body 2 to soil the device, thus reducing the cleaning workload. Therefore, the juices are prevented from sticking and hanging on an outer surface of pot body 2 to avoid a condition that the juices fall down on a kitchen countertop and to floor when the pot body is moved out of main machine 1.

In the present embodiment, since blocking frame 5 is a rectangular frame with an upper opening and a lower opening which are basically the same, the inner surface of the blocking frame includes four vertical planes. The sectional areas of feed passage 51 from the upper opening to the lower opening of the feed passage are constant. Of course, blocking frame 5 may adopt other shapes. For example, the inner surface of the blocking frame may comprise an outwardly inclined plane, an evaginable camber surface or an outwardly-folded combined plane. Correspondingly, the sectional areas of the feed passage become smaller and smaller from the upper opening to the lower opening of blocking frame 5 adopting the above structure, if a user overlooks the upper opening of blocking frame 5, he/she can see the entire inner surface of the blocking frame, and a cleaning tool can easily reach the entire inner surface, so that the cleaning is convenient and dirty dead corners are unlikely to be left.

When swinging to the first limit position shown in FIG. 6 and/or the second limit position shown in FIG. 7, spatula 3 is located above top opening 21 of pot body 2, and working face 31 of the spatula is located between top opening 21 and the upper opening of feed passage 51 in the height direction. Here, pot body 2 may be drawn out of the machine body in a slidable manner for pouring out of dishes and cleaning when separated from the main machine 1. Meanwhile, there is no block on spatula 3, so it is convenient to clean.

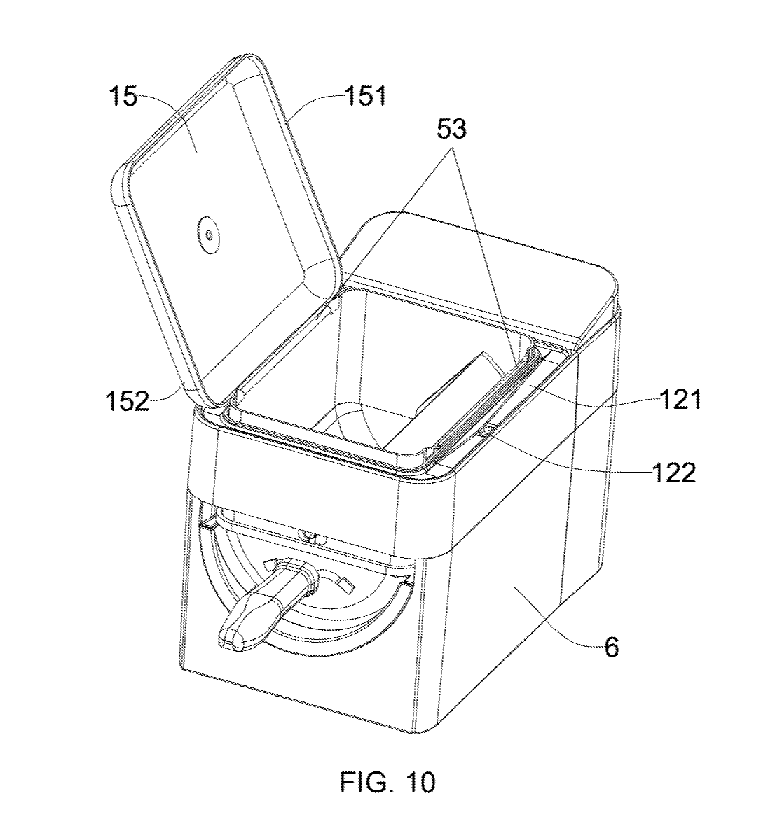

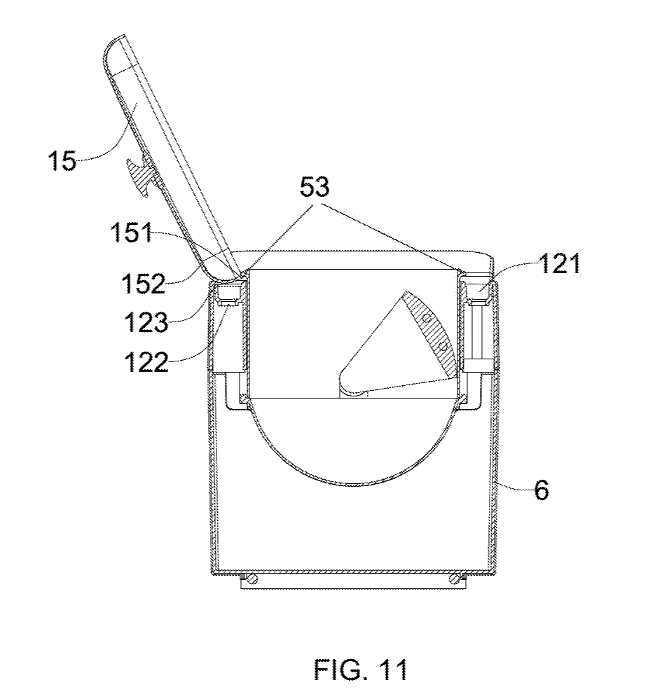

FIGS. 10 and 11 respectively show an automatic cooking device according to another embodiment of the present invention. The structure of the automatic cooking device is basically similar to that of automatic cooking device 10 shown in FIG. 1. However, in the present embodiment, arranging a protruding blocking part on a pot mouth encircling edge is only a preferred embodiment, but is not required. As shown in FIGS. 10 and 11, a circle of waste water trough 121 is arranged on an upper surface of frame 12, and water drainage hole 122 is arranged in waste water trough 121 and is in communication with waste water box 6. In addition, blocking frame flange 53 is arranged on an upper rim of blocking frame 5. When turned over, pot cover 15 may be vertically placed at the top of frame 12. The term “vertically placed” mentioned herein indicates that an included angel between a plane of pot cover 15 and the horizontal plane is obviously greater than that between the plane of pot cover 15 and the vertical plane, but is not limited to “vertical” in the strict sense. Here, inner rim 151 of pot cover 15 is in contact with a lower rim of blocking frame flange 53, and outer surface 152 of pot cover 15 is in contact with outer rim 123 of the waste water trough of frame 12, so that pot cover 15 can be placed stably. By applying this design, the automatic cooking device provided by the present invention has the following beneficial effects: 1) during normal cooking, there is distilled water on the inner surface of pot cover 15; if pot cover 15 is placed on the kitchen countertop, the distilled water will flow onto the kitchen countertop to soil the kitchen countertop; if pot cover 15 is vertically placed at the top of frame 12, there is no need to place pot cover 15 on the kitchen countertop randomly, so that the kitchen countertop is prevented from being soiled; 2) in a process from horizontally placed pot cover 15 in the closed state to the vertically placed pot cover in the open state, the distilled water on the inner surface of pot cover 15 flows to waste water trough 121 on the upper surface of frame 12, thus preventing the distilled water from flowing randomly; and 3) distilled water and other dirt gathered in waste water trough 121 may flow to waste water box 6 via water drainage hole 122, so that waste water is collected automatically, the surface of frame 12 is kept clean, and the cleaning workload is reduced.

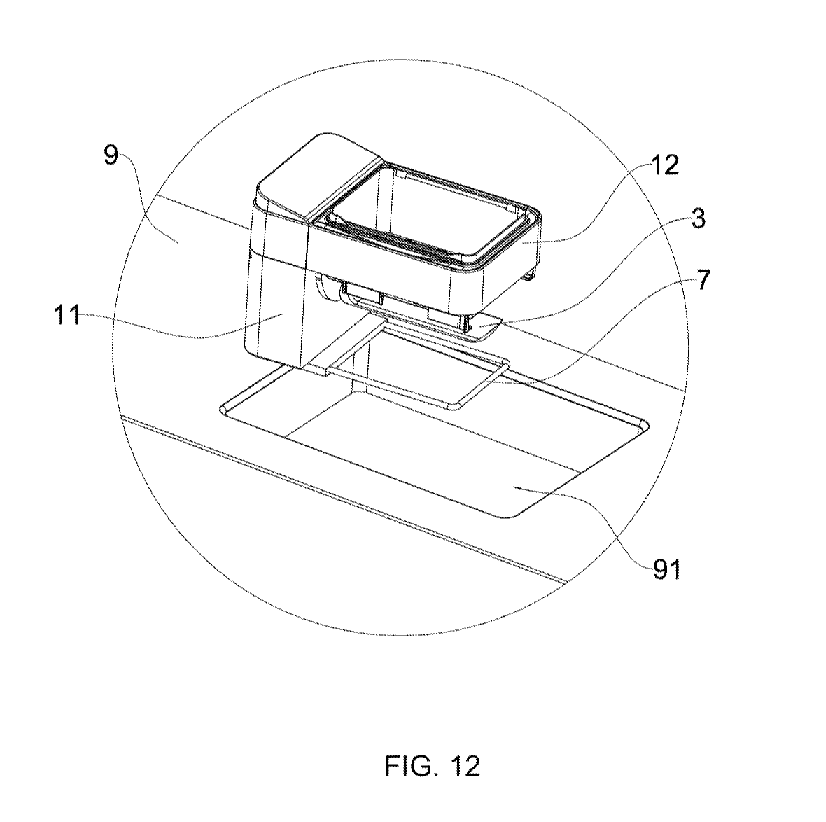

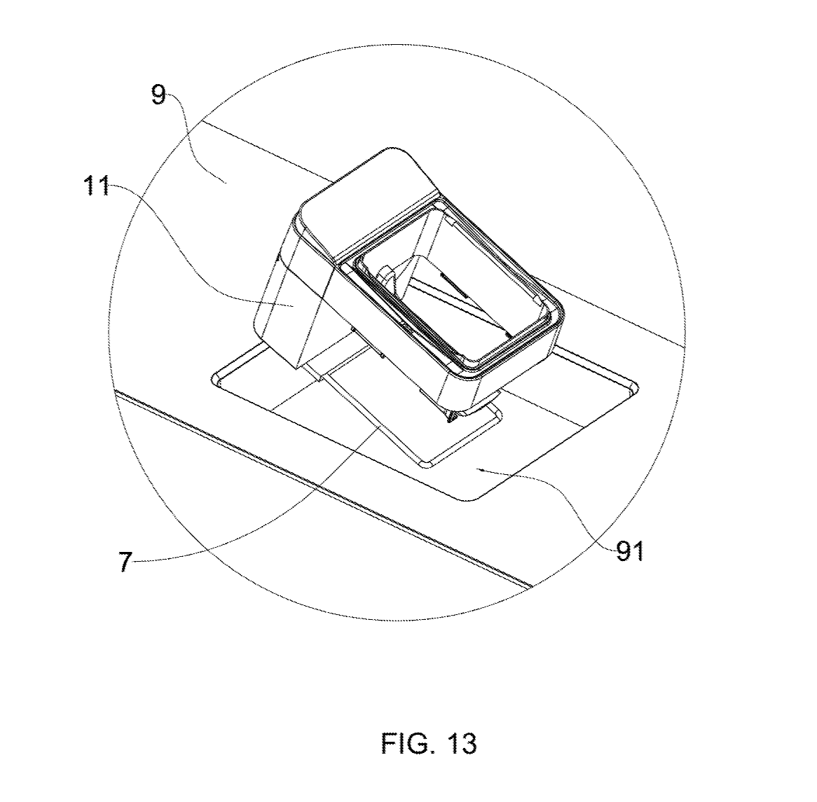

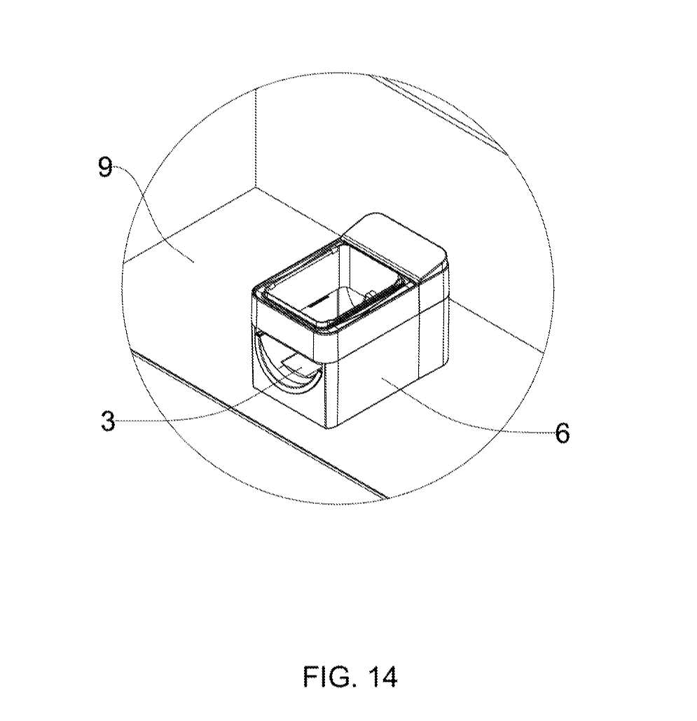

When automatic cooking device 10 provided by the present invention is cleaned, as shown in FIG. 12, at first, blocking frame 5, pot body 2 and waste water box 6 are separately dismantled from main machine 1. Then, the bottom of control box 11 of main machine 1 is horizontally placed on kitchen countertop 9, support 7 is hung above sink 91, and whole automatic cooking device 10 is horizontally placed. At the moment, a faucet is opened to directly clean frame 12, spatula 3 and the like, or the frame and the spatula are cleaned by a water-dipped tool. At last, waste water directly falls to the sink to be discharged. In addition, as shown in FIG. 13, the bottom of control box 11 leans on an upper rim of sink 91, support 7 leans at the bottom of sink 91, and whole automatic cooking device 10 is aslant placed. At the moment, the faucet is opened to directly clean frame 12, spatula 3 and the like, or the frame and the spatula are cleaned by the water-dipped tool. At last, waste water directly falls to the water trough to be discharged. Generally, an implementation manner shown in FIG. 14 is adopted. In this implementation manner, whole automatic cooking device 10 is horizontally placed on any kitchen countertop. After pot body 2 is taken out, blocking frame 5, spatula 3 and the like are washed via the water-dipped tool. Or, during the interval of cooking, few of vegetable residues stuck on blocking frame 5 and spatula 3 are pushed to waste water box 6 via a tool to be stored temporarily for continuing next cooking. If pot body 2 is not taken out water may be added into pot body 2 to soak spatula 3, and then the pot body and the spatula are cleaned via a cleaning tool.

Of course, the above-described embodiments are only the preferred embodiments of the present invention, and the technical features of the different embodiments can be combined and shared with one another. In practical application, the present invention may have more changes, but is not limited to the embodiments described above. For example, pot body 2 may be hemispherical or takes other appropriate shapes, and may be made of ceramics or other appropriate materials. Support 7 may be slab-shaped or mesh-shaped, or may have other shapes. Such changes can also achieve the objects of the present invention, so they are within the protection scope of the present invention as claimed in claims.

### INDUSTRIAL APPLICABILITY

The automatic cooking device provided by the present invention may be manufactured and used in the field of industry, and has the industrial applicability.

What is claimed is:

1. An automatic cooking device, comprising a maw machine, a pot body, a spatula, a spatula driving apparatus and a blocking frame located above the pot body, wherein the blocking, frame is provided with a feed passage with an upper opening and a lower opening; the lower opening of the feed passage is jointed with a top opening of the pot body; the spatula is located in a cavity encircled by the blocking frame and the pot body, is configured to swing in a reciprocating manner between a first limit position and a second limit position by means of the drive, of the spatula driving apparatus, and is provided with a working face which is opposite to a cooking face of the pot body and complementary with the cooking face in shape; the main machine comprises a control box and a frame; a pot mouth encircling edge is provided along an edge of the top opening of the pot body; at least one part of the pot mouth encircling edge and a lower rim of the blocking frame firm a slidable contact fit; a protruding blocking part is formed on the pot mouth encircling edge at the periphery of the blocking frame; and a top face of the blocking pan is higher than a joint seam between the pot mouth encircling edge and the lower rim of the blocking frame.

2. The automatic cooking device of claim 1, wherein after the blocking frame is detachably placed in the frame, the lower rim of the blocking frame and the pot mouth encircling edge form a slidable contact fit.

3. The automatic cooking device of claim 1, wherein an upper surface of the frame is provided with a waste water trough, a water drainage hole being arranged in the waste water trough and in communication with a waste water box.

4. The automatic cooking device of claim 3, wherein a pot cover is further arranged on the frame, the pot cover having a closed state when placed horizontally at the top of the frame and an open state when placed vertically at the to of the frame.

5. The automatic cooking device of claim 4, wherein a blocking frame flange is arranged on an upper rim of the blocking frame; and when the pot cover, vertically placed at the top of the frame, is in the open state, an inner rim of the pot cover is in contact with a lower rim of the blocking frame flange, and an outer surface of the pot cover is in contact with an outer rim of the waste water trough.

6. The automatic cooking device of claim 1, wherein hangers are arranged at a lower part of the frame and configured to support the pot body, and a lower surface of the pot mouth encircling edge and a supporting surface of the hangers form a slidable fit.

7. The automatic cooking device of claim 1, wherein the upper opening of the feed passage is larger than or equal to the lower opening of the feed passage, so that sectional areas of the feed passage keep constant or become smaller and smaller from the upper opening to the lower opening of the feed passage.

8. The automatic cooking device of claim 1, wherein an inner surface of the blocking frame comprises a vertical plane, an outwardly inclined plane, an evaginable camber surface or an outwardly-folded combined plane.

9. The automatic cooking device of claim 1, further comprising a waste water box which is detachably connected to the main machine and arranged below the pot body.

10. The automatic cooking device of claim 1, wherein a lower part of the main machine is connected with a support used for allowing the main machine to be stably placed during use or cleaning and/or for supporting the waste water box.

11. The automatic cooking device of claim 1, wherein the blocking part is arranged along an outer horizontal edge and two vertical edges of the pot mouth encircling edge.

12. The automatic cooking device of claim 1, wherein when swinging to the first limit position and/or the second limit position, the spatula is located above the top opening of the of body.

13-15. (canceled)
